(19) United States
(12) Patent Application Publication
(10) Pub. No.: US 2025/0271013 A1
(43) Pub. Date: Aug. 28, 2025

(54) Combined Lock and Tension Connector for Support Rods

(71) Applicant: House of Atlas, LLC, Evanston, IL (US)

(72) Inventors: Jason Moss, Libertyville, IL (US); Matthew Berman, Chicago, IL (US); Kang Yongzhang, Dongguan City (CN)

(21) Appl. No.: 18/585,716

(22) Filed: Feb. 23, 2024

(51) Int. Cl. F16B 7/10

(52) U.S. Cl. CPC F16B 7/105

(57) ABSTRACT

A connector for telescoping rods is provided including a core shaft and a locking sleeve. The core shaft includes a threaded portion having a first threading and a conical portion having a first frustoconical surface. The locking sleeve can receive at least a portion of the core shaft and defines a second threading that engages the first threading. In use, the internal locking connector is coupled to an inner rod and an outer rod such that rotating the inner rod and the outer rod relative to one another both increases tension of the rods against opposing mounting surfaces and locks the outer rod in a position relative to the inner rod.

### FIELD

This disclosure relates to support rods, and, more particularly, to lock and tensioning connectors for support rods.

### BACKGROUND

Support rods are used horizontally to support shower curtains, drapery, towels, clothes, or other items. They also are used vertically to hold baskets and other items. One common vertical use is a shower caddy. Typical support rods are adjustable and include an outer rod and an inner rod that slides telescopically in and out of the outer rod to adjust the overall length of the rods. A connector locks the outer and inner rods together at the desired adjusted length.

There is a need to improve connectors so that sufficient locking force is applied to prevent slippage between the two rods. There is also a need to simplify construction and use of a support rod so that a single mechanism both tensions the rods against the support surfaces and locks the two rods at the desired adjusted length.

### BRIEF DESCRIPTION OF THE DRAWINGS

FIG. 1 is an exploded view of a rod assembly according to an embodiment.

FIG. 2 is a front-side, first end perspective view of a connector of the rod assembly of FIG. 1.

FIG. 3 is a back-side, second end perspective view of the connector of FIG. 2.

FIG. 4 is a centrally taken cross-sectional view of the connector of FIG. 2 taken along line 8-8 of FIG. 3, shown inserted into an inner rod and an outer rod.

FIG. 5 is a front-side, second end perspective view of an insert of the connector of FIG. 2.

FIG. 6 is back-side, first end perspective view of the insert of the connector of FIG. 2.

FIG. 7 is a front-side, first end perspective view of a sleeve of the connector of FIG. 2.

FIG. 8 is a back-side, second end perspective view of the sleeve of the connector of FIG. 2.

### DETAILED DESCRIPTION

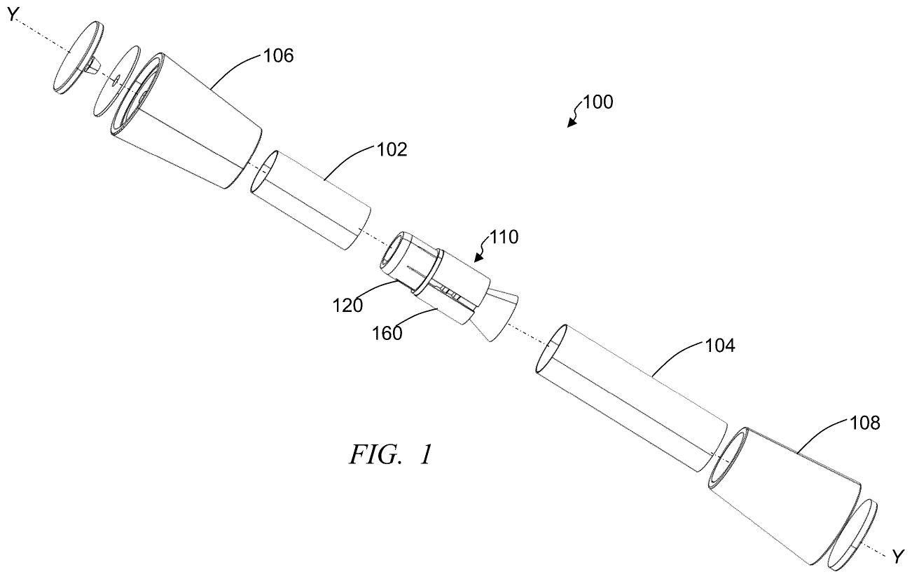

With reference to FIG. 1, there is illustrated a rod assembly 100 with a hollow, inner rod 102 and a hollow, outer rod 104. The inner rod 102 is telescopically received in the outer rod 104 to adjust the overall length of the rod assembly 100. Two end caps 106, 108 may be fitted to the inner rod 102 and the outer rod 104, respectively, to engage opposing support surfaces. The end caps may be adjustable or non-adjustable end caps, such as those described in U.S. Pat. Nos. 10,959,559, 11,382,447, U.S. Publication No. 2023/0277012, and in U.S. patent application Ser. No. 18/389,502, filed on Nov. 14, 2023, all of which are incorporated by reference herein in their entireties.

A connector 110 engages both the inner rod 102 and the outer rod 104 along a

central longitudinal axis y of the rod assembly 100. The connector 110 is a single mechanism having a dual purpose. Specifically, adjusting the connector 110 both locks the inner rod 102 and the outer rod 104 together and increases the tension of the inner rod 102 and the outer rod 104 against the opposing support surfaces.

More specifically, the connector 110 is configured so that simply rotating the inner rod 102 and the outer rod 104 relative to one another both locks the rods 102, 104 together at the desired length and moves the rods 102, 104 away from one another towards the opposing support surfaces to increase tension against the support surfaces.

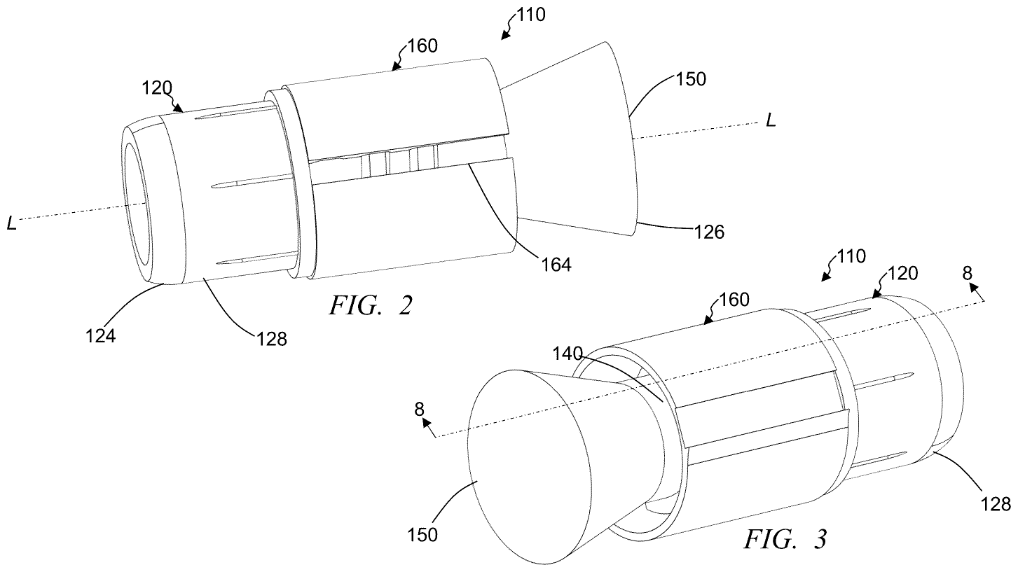

With reference to FIGS. 1-4, the connector 110 includes an insert 120 and a sleeve 160. A first end 124 of the insert 120 is configured to engage the inner rod 102, and a second end 126 of the insert 120 is configured to be inserted into the outer rod 104. The sleeve 160 has a split ring configuration and, in use, is disposed about the insert 120. The sleeve 160 is configured to displace relative to the insert 120 along a longitudinal axis L of the connector 110, as described further below, to selectively lock and unlock the inner rod 102 and outer rod 104.

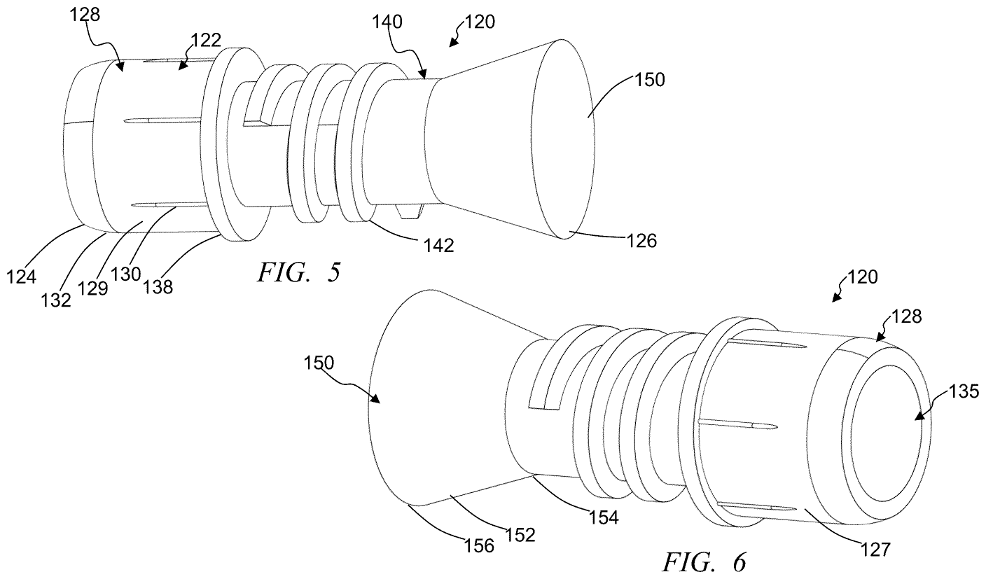

With reference to FIGS. 1, 4 and 5-6, the insert 120 is an elongated one-piece body 122. The body 122 includes an insert portion 128 extending from the first end 124, a conical or frustoconical portion of the body extending from the second end 126, and a shaft portion 140 extending therebetween that is partially threaded.

The insert portion 128 is generally cylindrical and is sized to be inserted within the inner rod 102. In embodiments, the insert portion 128 is sized to have a friction fit connection with the inner surface of the inner rod 102 so that the insert 120 is fixed from rotation relative to the inner rod 102. In some approaches, an outer side surface 129 of the insert portion 128 engages the inner surface of the inner rod 102. In some approaches, for instance as illustrated, a plurality of ribs (e.g., tapered ribs) may extend longitudinally along the outer side surface 129 to enhance the friction fit connection. In certain approaches, the insert portion 128 is inserted into the inner rod 102 during a manufacturing step and dimpled to further enhance friction and ensure the insert 120 does not rotate within the rod.

The insert portion 128 may also include a chamfered end portion 132 that facilitates insertion of the insert portion 128 into the inner rod 102. In embodiments, the insert portion 128 is hollow. For instance, the insert portion 128 may be defined by an annular wall 127 defining a central opening into a cavity 135. In some approaches, the insert portion 128 is hollow but the other portions of the insert 120 (e.g., the shaft portion 140 and the conical portion 150) are solid. In other approaches, the insert portion 128 is solid. By another approach, a central passage extends through the entire insert 120.

The insert 120 further includes an annular flange 138 that extends radially outwardly between and contiguous with the insert portion 128 and the shaft portion 140, having a greater radial extent than the insert portion 128 and the shaft portion 140. The annular flange 138 is radially positioned so that an end of the inner rod 102 may abut the annular flange 138 when the insert portion 128 is inserted therein. Thus, the annular flange 138 acts as a stop to prevent further insertion of the insert 120 into the inner rod 102. Specifically, the stop prevents the shaft portion 140 and the conical portion 150 from being inserted into the inner rod 102. As discussed below, the annular flange 138 is also positioned to stop displacement of the sleeve 160 relative to the insert 120.

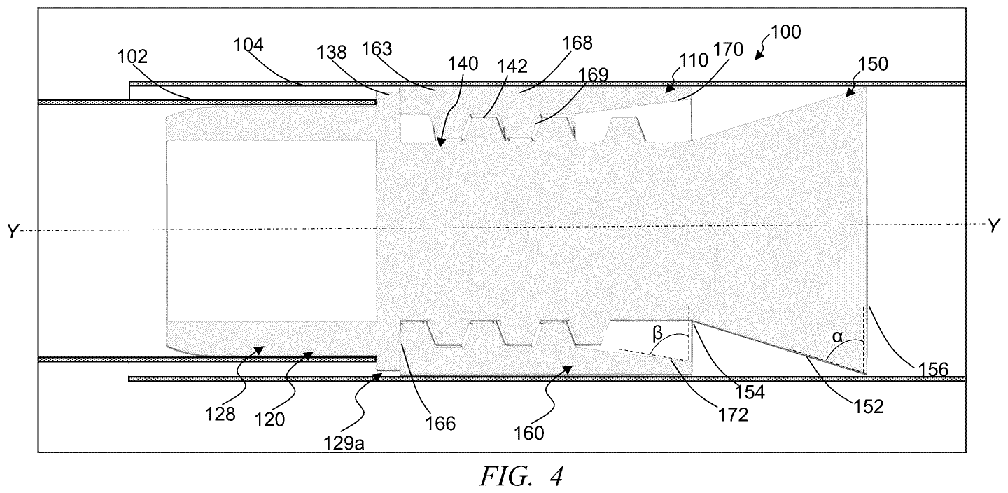

The outer diameter of the annular flange 138, in embodiments, is less than the inner diameter of the outer rod 104. For instance, as shown in FIG. 4, when the connector lock 110 is inserted within the inner rod 102 and the outer rod 104, the flange 138 and the outer rod 104 may define an annular space or gap 129a therebetween so that the flange 138 does not contact the outer rod 104. This ensures sufficient clearance for rotational displacement to occur between the inner rod 102 and the outer rod 104.

In some approaches, instead of a continuous annular flange 138 as illustrated, the flange 138 may be a discontinuous annular flange or may include a plurality of flanges spaced about the insert 120 to prevent further insertion of the insert 120 into the inner rod 102.

The shaft portion 140 is generally cylindrical and extends between the flange 138 and the conical portion 150. The shaft portion 140 includes external threading 142 disposed along a portion of the shaft portion. As illustrated, the external threading 142 does not extend to the flange 138 and the conical portion 150. The external threading engages internal threading 169 of the sleeve 160. The threading may be partial, discontinuous threading or may be continuous threading.

In embodiments, the diameter of the shaft portion 140 is less than the diameter of the insert portion 128. The narrowness of the shaft portion 140 allows a space for the locking sleeve 160 to extend about the shaft portion 140 while fitting within the outer rod 104.

The conical portion 150 extends from the shaft portion 140. The conical portion 150 has a gradually increasing diameter from a first end 154 of the conical portion 150 adjacent the shaft portion 140 to a second end 156. The gradually increasing diameter defines a frustoconical outer surface 152 of the conical portion 150 that acts as a wedge during the locking processes. In embodiments, the outer surface 152 is substantially angular. In certain approaches, the slope of the frustoconical outer surface 152 is such that an angle α (FIG. 4) defined between the frustoconical outer surface 152 and the surface at the second end 156 is at least about 45 degrees and at most about 89 degrees. In some embodiments, the angle α is at least about 60 degrees and at most about 85 degrees.

The maximum diameter of the conical portion 150 at the second end 156, in embodiments, is greater than the diameter at any other portion of the insert 120. For instance, in one approach, the conical portion 150 has a maximum diameter sized so that there is slight contact between the frustoconical outer surface 152 at the second end 156 with the inner surface of the outer rod 104. In some approaches, the frustoconical outer surface 152 does not contact the outer rod 104, and there is a slight gap therebetween. In any case, the maximum diameter of the conical portion 150 is selected relative to the inner diameter of the outer rod 104 to enable the conical portion 150 to force the sleeve 160 outwardly against the outer rod 104 to increase the tension between the sleeve 160 and the outer rod 104, as described further below.

The insert 120 may be formed from polymeric materials such as polycarbonate, polystyrene, polypropylene, acrylonitrile butadiene styrene (ABS), styrene acrylonitrile (SAN), polyurethane, polyvinyl chloride (PVC), nylon, rubber, etc. In some approaches, the material of the insert 120 may be a metal such as aluminum or stainless steel. The size of the insert 120 may vary based on the sizes of the rods the insert 120 is intended for. In one approach, the insert may have a main diameter at the insert portion 128 (not including the ribs 130) of about 0.625 inches (15.875 mm) to about 1.25 inches (31.75 mm) and a length of about 0.5 inches (12.7 mm) to about 2 inches (50.8 mm). In some approaches, the length of the insert portion 128 is about one fourth to about one half of the length of the entire insert 120, such as about one third.

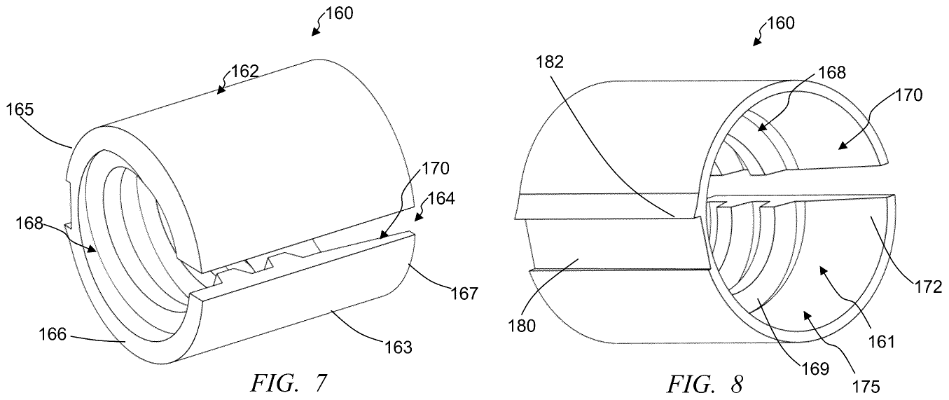

With reference to FIGS. 4 and 7-8, the sleeve 160 has a generally cylindrical, split ring configuration. Specifically, a cylindrical wall 162 defines a central passage 161 of the sleeve 160 which is sized to receive at least a portion of the insert 120 (e.g., the shaft portion 140). The split ring structure of the sleeve 160 defines a gap 164 in the cylindrical wall 162 which extends longitudinally an entire length of the cylindrical wall 162. The gap 164 provides flexibility to the sleeve 160 so that it can expand outwardly during the locking process. In addition, a coring 180 is defined in an exterior surface of the cylindrical wall 162 substantially opposite the gap 164, providing a thinned portion of the cylindrical wall 162. The coring 180 may extend longitudinally an entire length of the cylindrical wall and provides further flexibility to the sleeve 160. For instance, the coring, in embodiments, serves as a “living hinge” to facilitate outward expansion of the portions of the cylindrical wall 162 on opposite sides of the coring 180 during the locking process.

In embodiments, an angled projection 182 projects from the cylindrical wall 162 at one side of the coring 180. In embodiments, the angled projection 182 is positioned to engage the outer rod 104 when the sleeve 160 is inserted therein to create friction between the sleeve 160 and the outer rod 104 to resist rotation of the sleeve 160 during the locking processes. In some embodiments, the angled projection 182 functions to provide sufficient engagement between the sleeve 160 and the outer rod 104 to ensure the sleeve 160 will rotate with the outer rod 104 when the rods 102, 104 are twisted relative to one another during the locking function, while at the same time not creating too much friction to hinder telescoping of the rods 102, 104 relative to one another.

The sleeve 160 is sized so that it can be inserted into the outer rod 104. Specifically, an outer diameter of the sleeve 160 may be sized to permit light frictional engagement of an exterior cylindrical side surface 163 of the sleeve 160 with an inner surface of the outer rod 104 upon insertion of the sleeve 160 into the outer rod 104. Such light friction connection between the sleeve 160 and the outer rod 104 upon insertion may be sufficient to fix the sleeve 160 from rotation relative to the outer rod 104 during the locking process but also permit telescoping of the outer rod 104 relative to the inner rod 104. In some embodiments, the outer diameter of the sleeve 160 may be sized so that the sleeve 160 does not engage the outer rod 104 upon insertion into the outer rod 104 (e.g., there may be a slight gap), and the angled projection 182 is employed to rotationally fix the sleeve 160 relative to the outer rod 104. In some approaches, the exterior side surface 163 is entirely smooth to maximize contact with the inner surface of the outer rod 104. In other approaches, the exterior side surface 163 may include ribs or other projections to achieve a desired amount of friction.

An interior cylindrical surface 175 of the sleeve 160 includes internal threading 169 configured to cooperate with external threading 142 of the insert 120. A threaded portion 175 of the interior surface 175 containing the internal threading 169, in embodiments, may extend from a first end 165 of the sleeve 160 and along at least a portion of the length of the sleeve 160 towards a second end 167 of the sleeve 160. As illustrated, the internal threading 169 does not extend all the way to the second end 167. The threading may be partial, discontinuous threading or may be continuous threading.

The interior surface 175 also includes a smooth (non-threaded) angled or sloped portion 172 extending between the internal threading 169 and the second end 167. The interior angled surface 172 is defined by an annular tapered portion of the cylindrical wall 162. In embodiments, the tapering of the cylindrical wall 162 starts at the end of the internal threading 169 closest to the second end 167 and gradually tapers towards the second end 167, so that a thickness of the cylindrical wall 162 at the second end 167 is less than a thickness of the cylindrical wall at the internal threading 169. Specifically, the thickness of the cylindrical wall 162 at the first end 165 defines an annular face 166 at the first end 165 that may seat against or abut the flange 138 of the lock insert 120 when the shaft portion 140 is fully threaded into the locking sleeve 160.

In embodiments, the angle or slope of the interior angled surface 172 is selected so that when the interior angled surface 172 moves along the frustoconical surface 152 of the insert 120 during the locking process (described further below), engagement between the two surfaces 172, 152 causes the frustoconical surface 152 to exert pressure on the interior angled surface 172 and force the sleeve 160 to expand outwardly against the outer rod 104. In some configurations, the slope of the frustoconical surface 152 is greater than the slope of the interior angled surface 172, at least when the interior angled surface 172 is in its neutral position inserted into the outer rod 104 and not engaging the frustoconical surface 152.

In some approaches, an angle β (FIG. 4) defined between the interior angled surface 172 and a line extending from an end surface at the second end 167 of the sleeve 160 is at least about 45 degrees. A maximum may, for example, be about 89 degrees. In some embodiments, the angle β may be at least about 60 degrees or at least about 70 degrees.

In certain configurations, the angle β may be about 90 degrees and thus there is no tapered portion or angled surface. In some approaches, the angle β may be up to 95 degrees.

The sleeve 160 may be formed from a polymeric material such as polycarbonate, polystyrene, polypropylene, ABS, SAN, polyurethane, PVC, rubber, etc.

The size of the sleeve 160 may vary for use with rods of different sizes. In one example, the sleeve may be about 0.787 inches (20 mm) to about 1.181 inches (30 mm) in length with a length of the threaded portion being about 0.393 inches (10 mm) to about 0.787 inches (20 mm) and a length of the tapered portion being about 0.195 inches (5 mm) to about 0.590 inches (15 mm).

In some approaches, a thickness of the wall of the sleeve 160 at the threaded portion may be about 0.1 inches to about 0.2 inches, for example about 0.118 inches while the maximum thickness of the tapered portion may be about 0.1 inches to about 0.2 inches, for example about 0.118 inches and the minimum thickness about 0.02 to about 0.05 inches, for example about 0.039 inches. The thickness of the sleeve 160 at the cored out portion may, for example, be about 0.040 to about 0.060 inches, for instance about 0.049 inches, or at most about half the thickness of the sleeve 160 at the threaded portion.

FIG. 4 illustrates an initial, unlocked position of the connector 110 when the connector 110 is installed in the inner rod 102 and the outer rod 104. In this position, the connector 110 is selectively positioned relative to the outer rod 104 to adjust the total length of the rod assembly 100. During installation, the insert portion 128 of the rod connector 110 may already be inserted into the inner rod 102 so that the remainder of the insert 120 and the sleeve 160 coupled thereto protrude from the inner rod 102. For example, this pre-assembly may have occurred during a manufacturing step, which may include dimpling to adhere the components firmly together. In other approaches, the components 128, 102 may be glued or welded. In certain approaches, the rod connector 110 may not already be inserted into the inner rod 102 and the user inserts the insert portion 128 of the rod connector 110 into the inner rod 102.

During installation, the user adjusts the total length of the rod assembly 100 so that the rod assembly can extend between a first mounting surface and a second mounting surface (e.g., two opposing walls). To do so, the inner rod 102 and protruding parts of the connector 110 are inserted into the outer rod 104 and telescoped until the rod assembly 100 is the correct length. The farther the inner rod 102 and connector 110 are adjusted into the outer rod 104, the smaller the length of the rod assembly 100.

In the initial, unlocked position, the insert portion 128 of the insert 120 is inserted into end of the inner rod 102 with a connection that fixes the inner rod 102 and the insert 120 from rotation relative to one another when the inner rod 102 is rotated. The end of the inner rod 102 may abut the flange 138 of the insert 120 so that the rest of the insert 120 is not inserted into the inner rod 102 and instead protrudes therefrom.

The sleeve 160 is arranged about the shaft portion 140 of the insert 120 in the initial, unlocked position, fully threaded onto the shaft portion 140 of the insert 120 until the sleeve 160 abuts the flange 138. In some approaches, in the unlocked position, substantially the entirety of the sleeve 160 is arranged about or coextensive with the shaft portion 140. In this position, the interior angled surface 172 of the sleeve 160 does not engage the frustoconical surface 152 of the insert 120. In embodiments, in the initial unlocked position, the entirety of the conical portion 150 protrudes from the sleeve 160.

In some configurations, the sleeve 160 may be dimensioned so that it is always captivated on the insert 120 during normal use of the connector 110. For instance, a minimum inner diameter of the sleeve 160 defined by the internal threading 169, and/or a maximum flexibility of the locking sleeve 160, may limit the sleeve 160 from being completely removed from the insert 120 so that it is always between the flange 138 and the second end 156 of the conical portion 150. In other configurations, the sleeve 160 may be flexible enough to be removed from the insert 120.

In the unlocked position, the exterior surface 163 and/or the angled projection 182 of the sleeve 160 engage the inner surface of the outer rod 104. The amount of friction between the sleeve 160 and the outer rod 104 may be selected so that the outer rod 104 and the sleeve 160 are fixed from rotation relative to one another when the outer rod 104 is rotated, though still permitting the sleeve 160 and the outer rod 104 to slide longitudinally relative to one another with sufficient ease to adjust the length of the rod assembly 100.

As illustrated, when installed, the flange 138 of the insert 120 does not contact the outer rod 104, though the widest portion of the conical portion 150 may, in some embodiments, contact the outer rod 104.

After the length of the rod assembly 100 is adjusted so that the rods 102, 104 engage the opposing mounting surfaces, further tension is needed for a strong connection. In addition, further pressure is needed between the sleeve 160 and the outer rod 104 so that the outer rod 104 does not slip or move relative to the inner rod 102 during use of the rod assembly 100. Adjusting the connector 110 achieves both locking and tensioning.

Specifically, the user adjusts the connector 110 by rotating the inner rod 102 and the outer rod 104 relative to one another. For instance, in embodiments, the user twists both the inner rod 102 and the outer rod 104 simultaneously in opposite directions. The user may also firmly grasp one of the rods and simply rotate the other. When the inner rod 102 and the outer rod 104 are rotated relative to one another, the threaded connection between the sleeve 160 and the insert 120 causes the sleeve 160 and the insert 120 to move relative to one another. Specifically, the sleeve 160 is moved away from the flange 138 and towards the conical portion 150 of the insert 120.

When the sleeve 160 is moved towards the conical portion 150 (and/or the conical portion 150 is moved towards the sleeve 160), the interior angled surface 172 of the sleeve 160 engages the frustoconical surface 152 of the conical portion 150. The frustoconical surface 152 wedges against the angled surface 172 of the sleeve 160, exerting pressure against the angled surface 172 as the tapered end portion 170 of the sleeve 160 is forced into the gradually decreasing space between the frustoconical surface 152 and the outer rod 104. Specifically, the engagement between the surfaces results in the radially outward expansion of the locking sleeve 160 against the inner surface of the outer rod 104. The flexibility of the split-ring sleeve 160 facilitates the expansion. The outward expansion of the sleeve 160 against the outer rod 104 increases the friction force between the outer rod 104 and the sleeve 160 so that the outer rod 104 is firmly locked to the sleeve 160 (e.g., inhibited from linear or axial movement relative thereto) and, thus, locked in position with respect to the inner rod 102 without any slippage during use of the rod assembly 100. In addition, as the sleeve 160 becomes locked to the outer rod 104 and axially fixed relative to the outer rod 104, final twisting of the rods 102, 104 causes the sleeve 160 and the outer rod 104 to move together away from the inner rod 102, slightly increasing the total length of the rod assembly 100 and forcing the rods 102, 104 in greater tension against the opposing surfaces. Thus, a final “fine” adjustment of the rod assembly 100 against the mounting surfaces that increases the mounting tension is provided.

Accordingly, the connector 110 provides a simple mechanism for both increasing the tension of the rod assembly 100 against the mounting surfaces and locking the outer rod 104 and the inner rod 102 in position relative to one another.

To ensure that the rod assembly 100 is fully locked with maximum tension, the rods 102, 104 may be rotated relative to one another until rotation can no longer occur. This occurs when the angled surface 172 of the locking sleeve 160 and the frustoconical surface 152 of the lock insert 120 fully abut, the conical portion 150 being drawn almost entirely into the locking sleeve 160, and the distal end of the conical surface 172 applying radial pressure to the distal end of the angled surface 172 of the sleeve 160. That is, the final position of the rod assembly 100 achieved when the rods 102, 104 cannot be rotated any further, provides both maximum radial pressure to lock to rods 102, 104 in position and maximum tension of the rod assembly against the mounting surfaces.

To uninstall or unlock the rod assembly 100, the user reverses the twisting operation by twisting each of the outer rod 104 and the inner rod 102 in a direction opposite of the direction required for locking. This causes the outer rod 104 and the inner rod 102 to move towards each other via the threaded connection between the sleeve 160 and the insert 120. This decreases the tension against the mounting surfaces and/or disengages the rod assembly 100 from the mounting surfaces. In addition, this movement results in the interior angled surface 172 of the sleeve 160 disengaging from the frustoconical surface 152 of the conical portion 150 so that the sleeve 160 returns to its initial, non-expanded state. As a result, the outer rod 104 is slidable relative to the inner rod 102 and connector 110 so that the rods 102, 104 can be taken apart or so that the length of the rod assembly 100 can be further adjusted.

As noted above, a benefit of the connector 110 is that it provides a single mechanism that both increases the mounting tension of the rod assembly 100 and locks the rods 102, 104 in position relative to one another without slippage. Because the connector 110 permits a final fine adjustment of the rods 102, 104 against the mounting surfaces to increase the tension, the rod assembly 100 does not require other tensioning mechanisms, such as adjustable end caps.

A further benefit of the connector 110 is that it is simple to manufacture as it only includes two components (the insert 120 and the sleeve 160). Another advantage is that the connector 110 is contained entirely within the rods 102, 104 and thus obscured from view to maintain a clean appearance of the rod assembly 100.

In certain embodiments, a method of mounting an adjustable rod between two opposing mounting surfaces may include providing an inner rod with a connecter coupled to one end, the connector including a core shaft and a sleeve disposed about the core shaft, the core shaft including first threading and a conical portion and the sleeve including second threading cooperating with the first threading to move the sleeve and the core shaft relative to one another. The method may further include telescoping the inner rod and the connector within an outer rod to adjust a total combined length of the adjustable rod and rotating the inner rod and the outer rod relative to one another, wherein rotating the inner rod and the outer rod relative to one another moves the sleeve into engagement with the conical portion to expand the sleeve radially outwardly against the outer rod to lock the outer rod in position relative to the inner rod, and causes the inner rod and the outer rod to translate in opposite directions to increase a tension of the adjustable rod against the two opposing mounting surfaces.

While there have been illustrated and described particular embodiments of the present invention, those skilled in the art will recognize that a wide variety of modifications, alterations, and combinations can be made with respect to the above-described embodiments without departing from the scope of the invention, and that such modifications, alterations, and combinations are to be viewed as being within the ambit of the inventive concept.

What is claimed is:

1. A connector for telescoping rods comprising:
a core including a shaft portion with a first threading and a frustoconical portion having a first frustoconical surface; and
a sleeve capable of receiving at least a portion of the core and having a second threading and a second frustoconical surface,
wherein the second threading is engageable with the first threading to selectively displace the sleeve relative to the core between a first position where the first frustoconical surface and the second frustoconical surface are separated and a second position where the first frustoconical surface and the second frustoconical surface engage.

2. The connector of claim 1, the sleeve being radially expanded in the second position due to the engagement between the first frustoconical surface and the second frustoconical surface.

3. The connector of claim 1, the sleeve including an annular wall defining a gap extending along an entire length of the sleeve.

4. The connector of claim 3, wherein the sleeve defines a coring in the annular wall substantially opposite the gap to provide flexibility to the sleeve.

5. The connector of claim 1, wherein the sleeve includes an annular wall, the annular wall having a tapered portion forming the second frustoconical surface.

6. The connector of claim 5, wherein the tapered portion is disposed between the second threading and a terminal end of the sleeve.

7. The connector of claim 1, wherein the first threading of the core is intermediate the frustoconical portion and a non-threaded insert portion of the core.

8. The connector of claim 7, wherein the non-threaded insert portion has a first maximum diameter, the shaft portion has a second maximum diameter at the first threading, and the first maximum diameter is greater than the second maximum diameter.

9. The connector of claim 8, wherein the frustoconical portion has a third maximum diameter that is greater than the first maximum diameter of the non-threaded insert portion.

10. The connector of claim 7, further comprising a radial flange positioned between the non-threaded insert portion and the shaft portion.

11. The connector of claim 1, wherein the frustoconical portion increases in radial dimension from an inboard end to an outboard end of the frustoconical portion.

12. The connector of claim 1, wherein the shaft portion includes a first smooth surface between the first threading and the frustoconical portion.

13. The connector of claim 12 wherein the core includes a non-threaded insert portion, and the shaft portion includes a second smooth surface between the first threading and the non-threaded insert portion.

14. An adjustable rod comprising:
an inner rod and an outer rod mountable between opposing mounting surfaces, the inner rod capable of telescopically moving into and out from the outer rod to adjust a combined total length between the opposing mounting surfaces;
a core couplable at least in part to the inner rod and including a first threading and a wedge; and
a sleeve including a second threading that cooperates with the first threading, the sleeve disposable about the core and within the outer rod and sized to engage the outer rod,
wherein rotating the inner rod relative to the outer rod in a first direction increases a tension of the adjustable rod against the opposing mounting surfaces and increases pressure between the sleeve and the outer rod to lock the inner rod and the outer rod in position relative to one another.

15. The adjustable rod of claim 14, the core including an insert portion insertable within the inner rod to frictionally engage the inner rod to restrict rotation of the core relative to the inner rod.

16. The adjustable rod of claim 15, the core including a shaft portion disposed intermediate the insert portion and the wedge, the shaft portion including the first threading.

17. The adjustable rod of claim 14, wherein the sleeve is sized so that at least a portion of the sleeve frictionally engages the outer rod to restrict rotation of the sleeve relative to the outer rod while permitting axial movement relative to the outer rod.

18. The adjustable rod of claim 14, the sleeve including an inner frustoconical surface capable of engaging the wedge when the inner rod is rotated relative to the outer rod in the first direction, the wedge causing expansion of the sleeve to increase the pressure between the sleeve and the outer rod to lock the inner rod and the outer rod in position relative to one another.

19. The adjustable rod of claim 18, the sleeve including an annular wall, the annular wall including the inner frustoconical surface.

20. The adjustable rod of claim 14, the sleeve defining an annular wall having a split therein extending longitudinally an entire length of the sleeve and a coring substantially opposite the split to provide flexibility to the sleeve.
